(19) United States
(12) Patent Application Publication
(10) Pub. No.: US 2015/0088797 A1
(43) Pub. Date: Mar. 26, 2015

(54) SYNAPSE CIRCUITS FOR CONNECTING NEURON CIRCUITS, UNIT CELLS COMPOSING NEUROMORPHIC CIRCUIT, AND NEUROMORPHIC CIRCUITS

(71) Applicant: Samsung Electronics Co., Ltd., Suwon-Si (KR)

(72) Inventors: Youngbae KIM, Seoul (KR); Moongu JEON, Gwangju (KR); Byunggeun LEE, Gwangju (KR); Ahmad Muqeem SHERI, Gwangju (KR); Hyunguk CHOI, Gwangju (KR)

(73) Assignee: GWANGJU INSTITUTE OF SCIENCE AND TECHNOLOGY, Gwangju (KR)

(21) Appl. No.: 14/496,568

(22) Filed: Sep. 25, 2014

(30) Foreign Application Priority Data
Sep. 26, 2013 (KR) 10-2013-0114695

(51) Int. Cl. G06N 3/04; G06N 3/063

(52) U.S. Cl. CPC G06N 3/0454; G06N 3/063
USPC 706/29

(57) ABSTRACT

Example embodiments relate to a synapse circuit connecting neuron circuits by using two memristors so as to enhance symmetry, a neuromorphic circuit using the same, and a unit cell composing the neuromorphic circuit.

### RELATED APPLICATION

This application claims the benefit of priority from Korean Patent Application No. 10-2013-0114695, filed on Sep. 26, 2013, in the Korean Intellectual Property Office, the disclosure of which is incorporated herein in its entirety by reference.

### BACKGROUND

1. Field

Example embodiments relate to synapse circuits for connecting neuron circuits, neuromorphic circuits using the same, and/or unit cells composing the neuromorphic circuit.

2. Description of the Related Art

Interest in a neuromorphic circuit that is same as or similar to a human nervous system is increasing. Research is being done to design a neuron circuit and a synapse circuit respectively corresponding to a neuron and a synapse that are included in the human nervous system, to implement a neuromorphic circuit. The neuromorphic circuit may be applied to the field of classifying data or recognizing patterns.

### SUMMARY

Example embodiments relate to synapse circuits that connect neuron circuits by using two memristors so as to enhance symmetry, neuromorphic circuits using the same, and/or unit cells composing the neuromorphic circuit.

Additional example embodiments will be set forth in part in the description that follows and, in part, will be apparent from the description, or may be learned by practice of the example embodiments.

According to at least one example embodiment, a synapse circuit connecting a plurality of neuron circuits includes a first memristor connected to a pre-synaptic neuron circuit, a second memristor connected to the pre-synaptic neuron circuit and an adder configured to output a sum of signals, respectively output from the first and second memristors, to a post-synaptic neuron circuit.

According to another example embodiment, a unit cell composing a neuromorphic circuit includes a pre-synaptic neuron circuit, a pre-synaptic neuron circuit, and a synapse circuit connecting the pre-synaptic neuron circuit and the post-synaptic neuron circuit, wherein the synapse circuit is configured to output a sum of signals, respectively output from two memristors connected to the pre-synaptic neuron circuit, to the post-synaptic neuron circuit.

According to another example embodiment, a neuromorphic circuit includes a plurality of pre-synaptic neuron circuits, a plurality of post-synaptic neuron circuits, and a plurality of synapse circuits arranged in a grid structure, each including two memristors, and being configured to output a sum of signals respectively output from two memristors, wherein the plurality of synapse circuits arranged on the same row in the grid structure are connected to one of the plurality of pre-synaptic neuron circuits, and the plurality of synapse circuits on the same column in the grid structure are connected to one of the plurality of post-synaptic neuron circuits.

### BRIEF DESCRIPTION OF THE DRAWINGS

These and/or other example embodiments will become apparent and more readily appreciated from the following description of the example embodiments, taken in conjunction with the accompanying drawings in which:

FIG. 1 is a diagram for describing a neuromorphic circuit, according to at least one example embodiment;

FIG. 2 is a block diagram of a unit cell composing the neuromorphic circuit according to at least one example embodiment;

FIG. 3 is a detailed block diagram of a synapse circuit connecting neuron circuits according to at least one example embodiment;

FIGS. 4A and 4B are diagrams for describing a read cycle of the neuromorphic circuit, according to at least one example embodiment;

FIG. 5 is a diagram describing a spiking input and a non-spiking input;

FIGS. 6A and 6B are diagrams describing a write cycle of the neuromorphic circuit, according to at least one example embodiment; and

FIGS. 7A and 7B are diagrams for describing a sleep cycle of the neuromorphic circuit, according to at least one example embodiment.

### DETAILED DESCRIPTION

Reference will now be made in detail to example embodiments illustrated in the accompanying drawings, wherein like reference numerals refer to like elements throughout. In this regard, the example embodiments may have different forms and should not be construed as being limited to the descriptions set forth herein. Accordingly, the example embodiments are merely described below, by referring to the figures. Expressions such as “at least one of,” when preceding a list of elements, modify the entire list of elements and do not modify the individual elements of the list.

Numerous modifications and adaptations will be readily apparent to those of ordinary skill in the art without departing from the spirit and scope of the example embodiments.

The term “include” or “comprise” used herein should not be interpreted to include all the various stages of the various components described in the specification, or some of these steps: may not be included or additional components or steps that can and should be interpreted.

It will be understood that when an element is referred to as being “on,” “connected” or “coupled” to another element, it can be directly on, connected or coupled to the other element or intervening elements may be present. In contrast, when an element is referred to as being “directly on,” “directly connected” or “directly coupled” to another element, there are no intervening elements present. As used herein the term “and/or” includes any and all combinations of one or more of the associated listed items. Further, it will be understood that when a layer is referred to as being “under” another layer, it can be directly under or one or more intervening layers may also be present. In addition, it will also be understood that when a layer is referred to as being “between” two layers, it can be the only layer between the two layers, or one or more intervening layers may also be present.

It will be understood that although the terms such as “first” or “second” are used herein to describe various elements, components, regions, layers and/or sections, these elements, components, regions, layers and/or sections, should not be limited by these terms. These terms are only used to distinguish one element, component, region, layer and/or section from another element, component, region, layer or section. Thus, a first element, component, region, layer or section discussed below could be termed a second element, component, region, layer or section without departing from the teachings of example embodiments.

In the drawing figures, the dimensions of layers and regions may be exaggerated for clarity of illustration. Like reference numerals refer to like elements throughout. The same reference numbers indicate the same components throughout the specification.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein. As used herein, expressions such as “at least one of,” when preceding a list of elements, modify the entire list of elements and do not modify the individual elements of the list.

Example embodiments relate to a synapse circuit connecting neuron circuits, a neuromorphic circuit using the same, and/or a unit cell composing the neuromorphic circuit. In the example embodiments, a detailed description on details known to one of ordinary skill in the art is not provided.

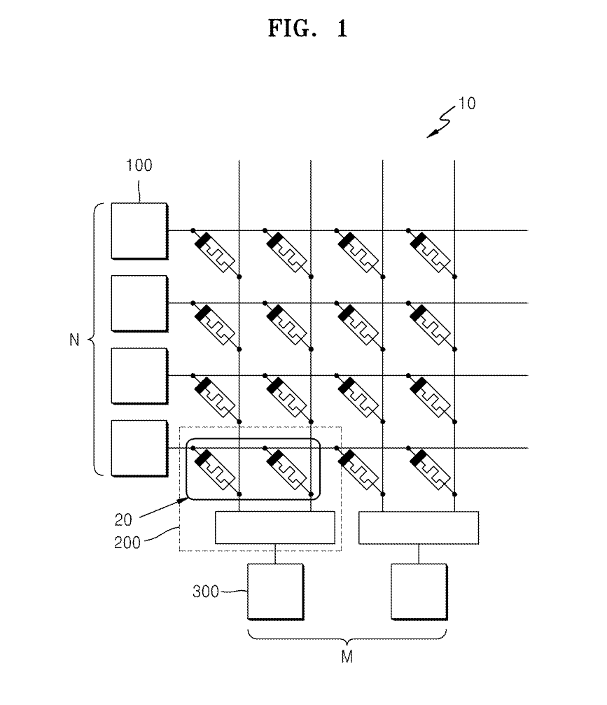

FIG. 1 is a diagram describing a neuromorphic circuit 10 according to an example embodiment.

Referring to FIG. 1, the example neuromorphic circuit 10 includes a plurality of pre-synaptic neuron circuits, a plurality of post-synaptic neuron circuits, and a plurality of synapse circuits. In FIG. 1, the neuromorphic circuit 10 having an N x M matrix structure including N number of pre-synaptic neuron circuits and M number of post-synaptic neuron circuits is illustrated.

Each of the plurality of synapse circuits may include a plurality of memristors, and one synapse circuit 200 may have a structure including two memristors, namely, a pair of memristors 20. Two memristors included in each of the plurality of synapse circuits may be connected to each other in a parallel structure.

The plurality of synapse circuits may be arranged in a grid structure or a matrix structure. In the grid structure or the matrix structure, one end of each of a plurality of synapse circuits arranged on the same row may be connected to one pre-synaptic neuron circuit 100 of the plurality of pre-synaptic neuron circuits 100. Also, in the grid structure or the matrix structure, one end of each of a plurality of synapse circuits arranged on the same column may be connected to one post-synaptic neuron circuit 300 of the plurality of post-synaptic neuron circuits 300. In other words, a plurality of synapse circuits arranged on the same row may be connected to one of the plurality of pre-synaptic neuron circuits 100, and a plurality of synapse circuits arranged on the same column in the grid structure may be connected to one of the plurality of post-synaptic neuron circuits 300.

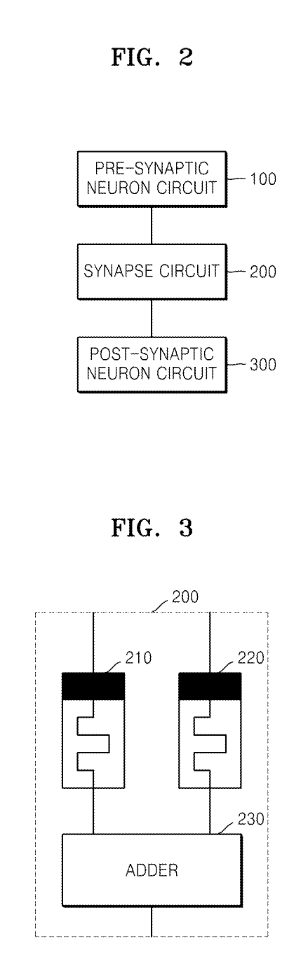

One synapse circuit 200 of the plurality of synapse circuits may connect one pre-synaptic neuron circuit 100 to one post-synaptic neuron circuit 300. Hereinafter, unit cells composing the neuromorphic circuit 10 will be described in detail with reference to FIGS. 2 and 3.

FIG. 2 is a block diagram of a unit cell composing the neuromorphic circuit 10, according to an example embodiment. One of ordinary skill in the art understands that the unit cell according to an example embodiment may further include general-use elements in addition to elements of FIG. 2.

Referring to FIG. 2, the synapse circuit 200 is provided between the pre-synaptic neuron circuit 100 and the post-synaptic neuron circuit 300. The pre-synaptic neuron circuit 100, synapse circuit 200, and post-synaptic neuron circuit 300 may be a unit cell composing the neuromorphic circuit 10. The synapse circuit 200 may have a structure in which a sum of signals respectively output from two memristors connected to the pre-synaptic neuron circuit 100 is output to the post-synaptic neuron circuit 300. Hereinafter, the synapse circuit 200 will be described in detail with reference to FIG. 3.

FIG. 3 is a detailed block diagram of the synapse circuit 200 connecting neuron circuits according to an example embodiment. One of ordinary skill in the art understands that the synapse circuit 200 may further include general-use elements in addition to elements of FIG. 3.

Referring to FIG. 3, the synapse circuit 200 may include a first memristor 210, a second memristor 220, and an adder 230.

The synapse circuit 200 may include the first and second memristors 210 and 220, one end of each being connected to the pre-synaptic neuron circuit 100, and the adder 230 connected to the other end of each of the first and second memristors 210 and 220. The synapse circuit 200 may be, e.g., an interface apparatus that connects two neuron circuits.

One end of each of the first and second memristors 210 and 220 may receive an input from the pre-synaptic neuron circuit 100, and an output from the other end of each of the first and second memristors 210 and 220 may be transferred to the adder 230. The adder 230 may output a sum of input signals to the post-synaptic neuron circuit 300 on the basis of the input from each of the first and second memristors 210 and 220.

The first and second memristors 210 and 220 may be provided between the pre-synaptic neuron circuit 100 and the post-synaptic neuron circuit 300, and may be connected to each other in, e.g., a parallel structure. In this example, the first and second memristors 210 and 220 may be connected to each other in the same polarity direction. Each of the first and second memristors 210 and 220 is an element having an asymmetrical operation characteristic, but a pair of memristors is added into the synapse circuit 200, thus enhancing a symmetry of the synapse circuit 200.

The adder 230 may receive an output of each of the first and second memristors 210 and 220 as an input, and calculate the sum of the input signals. To this end, the adder 230 may include at least one adder. For example, the adder 230 may add an output of the first memristor 210 and a sign-inverted output of the second memristor 220. In this case, if the output of each of the first and second memristors 210 and 220 has a value within a range of about 0 to about 1, an output of the adder 230 may have a value within a range of about −1 to about 1.

The first and second memristors 210 and 220 may perform opposite functions in changing a state of a neuron circuit. For example, the first memristor 210 may perform long-term potentiation (LTP), and the second memristor 220 may perform long-term depression (LTD). In this case, so that one synapse circuit 200 including two memristors operates correctly, a read cycle and a write cycle may be used. Hereinafter, a relevant description will be made with reference to the drawings.

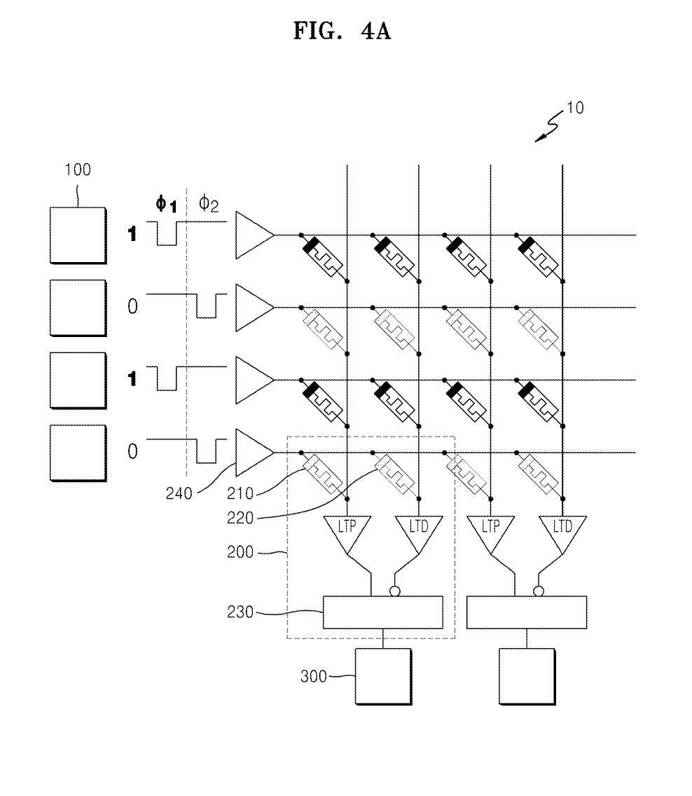

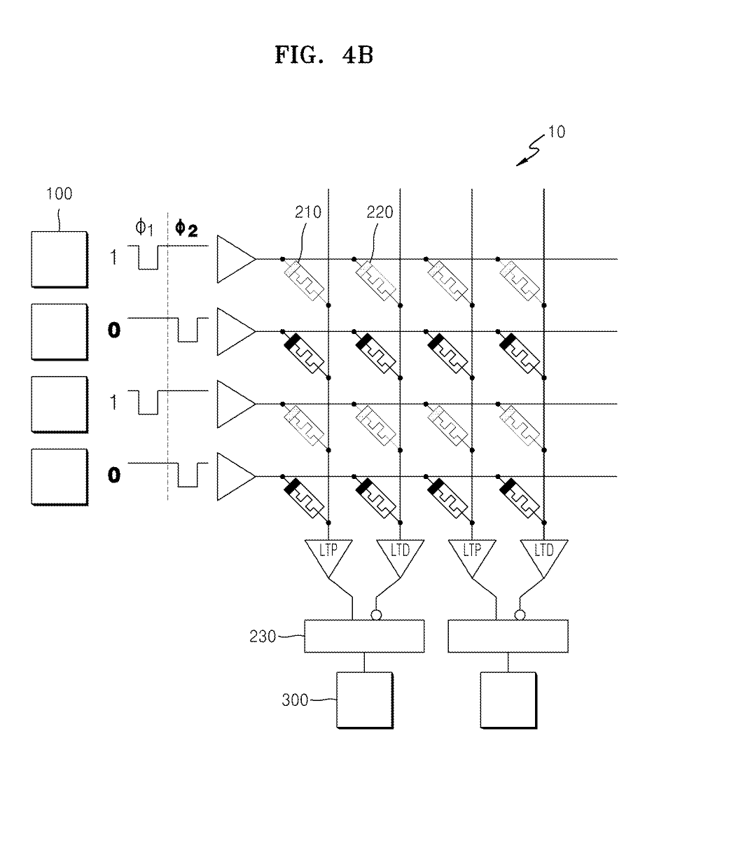

FIGS. 4A and 4B are diagrams for describing a read cycle of the neuromorphic circuit 10, according to an example embodiment.

Referring to FIGS. 4A and 4B, in the neuromorphic circuit 10, the plurality of pre-synaptic neuron circuits, the plurality of synapse circuits, and the post-synaptic neuron circuits are connected to each other through a plurality of wires or other connecting structure. In FIGS. 4A and 4B, the neuromorphic circuit 10 having a 4×2 matrix structure in which four pre-synaptic neuron circuits are connected to two post-synaptic neuron circuits is illustrated. In particular, the matrix structure is a structure in which the two memristors, namely, the first and second memristors 210 and 220, are connected between one pre-synaptic neuron circuit 100 and one post-synaptic neuron circuit 300. As illustrated in FIGS. 4A and 4B, the synapse circuit 200 may include a buffer 240 depending on the case.

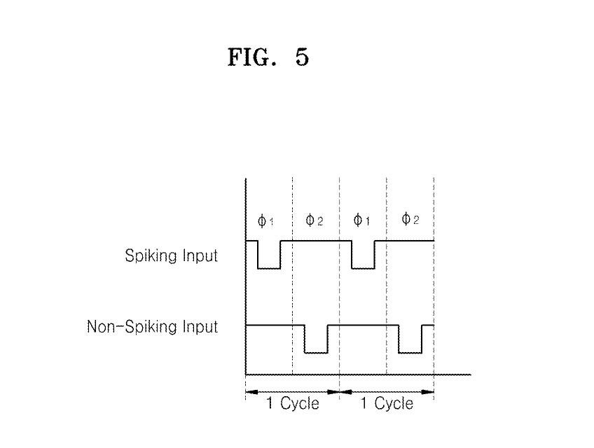

In FIGS. 4A and 4B, 0 and 1 denote input data that is output from the pre-synaptic neuron circuit 100. Also, the pre-synaptic neuron circuit 100 generates spiking signals having different phases. The pre-synaptic neuron circuit 100 transfers the input data to the post-synaptic neuron circuit 300 according to the spiking signal. Hereinafter, the spiking signal will be described with reference to FIG. 5.

FIG. 5 is a diagram describing a spiking input and a non-spiking input.

The spiking signal may be generated by the pre-synaptic neuron circuit 100 or the post-synaptic neuron circuit 300. The spiking signal may be fired according to a desired, or alternatively predetermined cycle. The desired, or alternatively predetermined cycle at which the spiking signal is fired may be divided into a plurality of sections having different phases. Referring to FIG. 5, one cycle may include a section having a phase Ø₁ and a section having a phase Ø₂.

When the desired, or alternatively predetermined cycle is divided into two sections having different phases, a spiking input denotes a case in which a pulse is generated in a pre-section having the phase Ø₁.

On the other hand, when the desired, or alternatively predetermined cycle is divided into two sections having different phases, a non-spiking input denotes a case in which a pulse is generated in a post-section having the phase Ø₂.

Therefore, spiking signals having different phases may be fired in one cycle. That is, a pulse based on the spiking input may be transferred to the post-synaptic neuron circuit 300 in the pre-section having the phase Ø₁, and a pulse based on the non-spiking input may be transferred to the post-synaptic neuron circuit 300 in the post-section having the phase Ø₂.

Referring again to FIGS. 4A and 4B, FIG. 4A illustrates operations of the synapse circuits 200 that are performed according to the pulse based on the spiking input in the pre-section having the phase Ø₁ of the desired, or alternatively predetermined cycle, and FIG. 4B illustrates operations of the synapse circuits 200 that are performed according to the pulse based on the non-spiking input in the post-section having the phase Ø₂ of the desired, or alternatively predetermined cycle.

The first memristor 210 may be an element that performs LTP, and the second memristor 220 may be an element that performs LTD. The output of the adder 230 that is transferred to the post-synaptic neuron circuit 300 may be determined based on a current output from each of the first and second memristors 210 and 220.

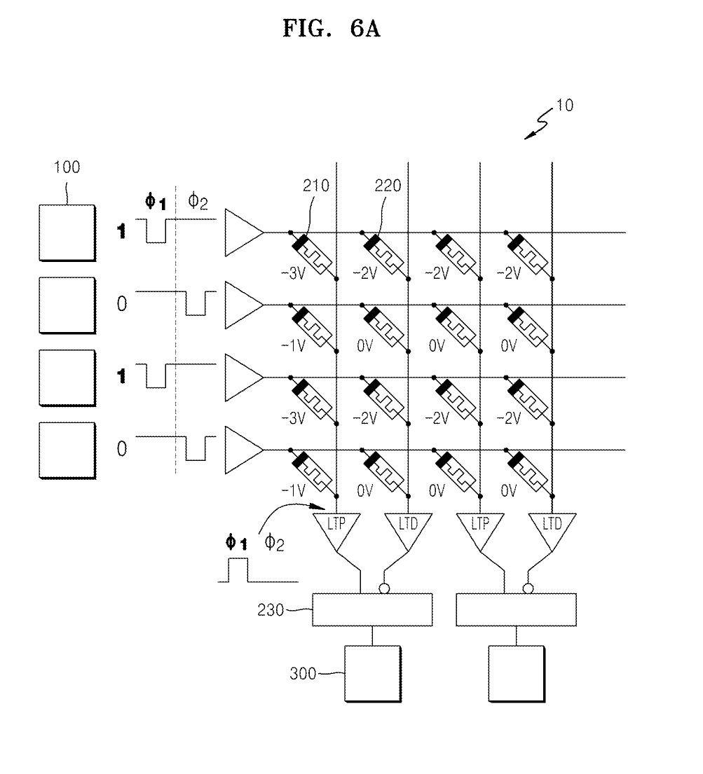

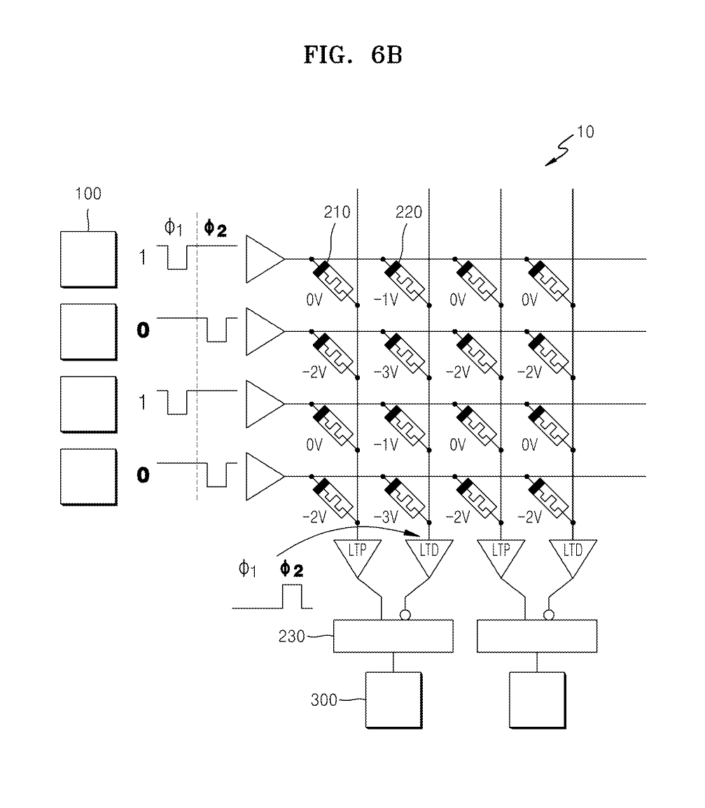

FIGS. 6A and 6B are diagrams for describing a write cycle of the neuromorphic circuit 10, according to an example embodiment.

Referring to FIGS. 6A and 6B, all memristors included in the neuromorphic circuit 10 have a threshold voltage. When a voltage lower than the threshold voltage is applied to the memristors, a conductance of each of the memristors is not changed. On the other hand, when a voltage higher than the threshold voltage is applied to the memristors, the conductance of each of the memristors may be changed.

The connection strength between the pre-synaptic neuron circuit 100 and the post-synaptic neuron circuit 300 may also be changed by changing the conductance of each memristor. That is, the synapse circuit 200 may change the connection strength by varying the conductance of each memristor.

The synapse circuit 200 including the two memristors, namely, the first and second memristors 210 and 220, may increase a conductance of the first memristor 210 corresponding to an element performing LTP, and may maintain a conductance of the second memristor 220 corresponding to an element performing LTD, thereby potentiating or increasing the connection strength between the pre-synaptic neuron circuit 100 and the post-synaptic neuron circuit 300.

On the other hand, the synapse circuit 200 including the two memristors namely, the first and second memristors 210 and 220, may maintain the conductance of the first memristor 210 corresponding to the element performing LTP, and may change the conductance of the second memristor 220 (corresponding to the element performing the LTD) to a low-resistance state, thereby depressing or reducing the connection strength between the pre-synaptic neuron circuit 100 and the post-synaptic neuron circuit 300.

The write cycle of the neuromorphic circuit 10 according to an example embodiment is executed similarly to the read cycle including the two sections having different phases of FIGS. 4A and 4B. However, a back-spiking signal is input to an output terminal of each memristor, thereby changing the conductance of each memristor.

Referring to FIG. 6A, in the synapse circuit 200, connection strength between the neuron circuits may be potentiated in the pre-section having the phase Ø₁ of the desired, or alternatively predetermined cycle. Referring to FIG. 6B, in the synapse circuit 200, the connection strength between the neuron circuits may be depressed in the post-section having the phase Ø₂ of the desired, or alternatively predetermined cycle.

Referring to FIG. 6A, the connection strength between the pre-synaptic neuron circuit 100 and the post-synaptic neuron circuit 300 may be potentiated in the pre-section having the phase Ø₁ of the desired, or alternatively predetermined cycle. Pulses having opposite signs may be respectively applied to both terminals of the first memristor 210 corresponding to the element performing LTP, and thus, a voltage exceeding the threshold voltage of the first memristor 210 may be applied to the first memristor 210. Therefore, a voltage is substantially decreased at one end of the first memristor 210, thereby increasing the conductance of the first memristor 210. As illustrated in FIG. 6A, the spiking signal having a negative value may be applied in the pre-section having the phase Ø₁, but, as illustrated in a left lower end of FIG. 6A, a back-spiking signal having a positive value may be applied. At this time, the second memristor 220 corresponding to the element performing LTD is not changed.

Referring to FIG. 6B, the connection strength between the pre-synaptic neuron circuit 100 and the post-synaptic neuron circuit 300 may be reduced in the post-section having the phase Ø₂ of the desired, or alternatively predetermined cycle. Pulses having opposite signs may be respectively applied to both terminals of the second memristor 220 corresponding to the element performing LTD, and thus, a voltage exceeding the threshold voltage of the second memristor 220 may be applied to the second memristor 220. Therefore, a voltage is substantially decreased at one end of the second memristor 220, thereby increasing the conductance of the second memristor 220. As illustrated in FIG. 6B, the spiking signal having a negative value may be applied in the post-section having the phase Ø₂, but, as illustrated in a left lower end of FIG. 6B, the back-spiking signal having a positive value may be applied. At this time, the first memristor 210 corresponding to the element performing LTP is not changed.

A plurality of spiking signals, which have different phases and are respectively fired by the plurality of pre-synaptic neuron circuits, may be respectively input to the synapse circuits in different sections of an operation cycle of each of the synapse circuits, according to at least one example embodiment.

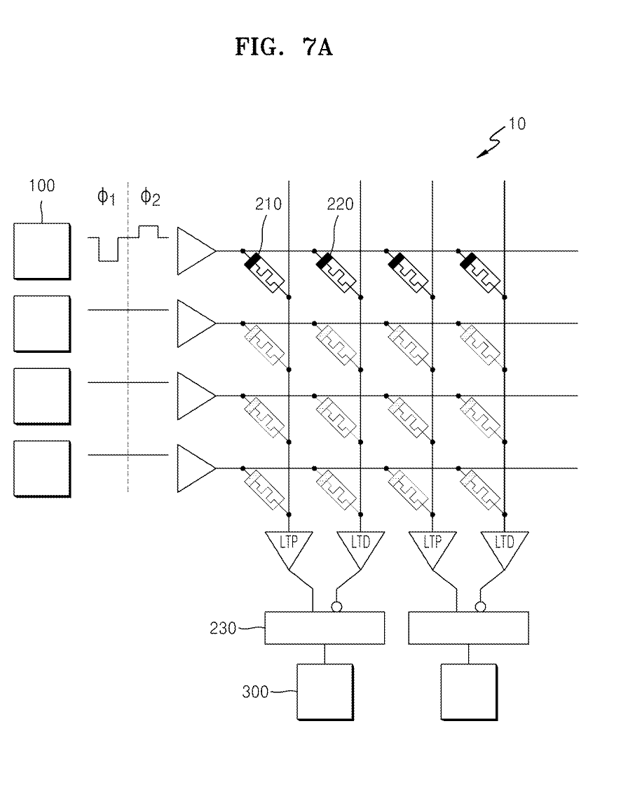

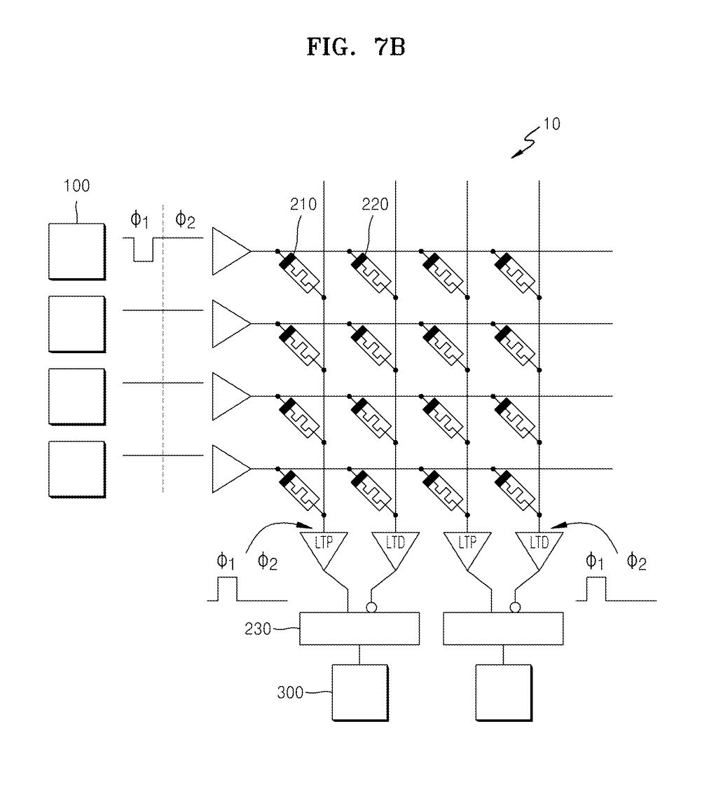

FIGS. 7A and 7B are diagrams for describing a sleep cycle of the neuromorphic circuit 10, according to an example embodiment.

When the plurality of memristors included in the synapse circuit 200 are continuously used, the conductance of each of the memristors may reach a low-resistance limit. In particular, when the memristors are continuously used, the memristors may be permanently damaged. Therefore, the sleep cycle is provided for extending a service life of each of the memristors.

The sleep cycle may start to be executed along with one signal transferred to all the memristors in the neuromorphic circuit 10. A system is fully set to a sleep mode in a next clock cycle. During the sleep mode, there is no input or no input is provided.

Referring to FIG. 7A, a read-reset pulse may be applied to a pair of memristors connected to each of the pre-synaptic neuron circuits. Conductance of each of a first pair of memristors 210 and 220 may be read and stored by using a pulse in the pre-section having the phase Ø₁. A reset pulse may be applied by setting all the elements to a high-resistance state in the post-section having the phase Ø₂.

Referring to FIG. 7B, in order to recover a stored conductance, back-spiking signals having different cycles may be generated by the post-synaptic neuron circuits. Such an operation may be performed for all the pre-synaptic neuron circuits using the synapse circuit 200 including the pair of memristors.

As described above, according to the one or more of the above example embodiments, the symmetry of the synapse circuit connecting the neuron circuits is enhanced, and thus, hardware of the neuromorphic circuit is improved.

It should be understood that the example embodiments described therein should be considered in a descriptive sense only and not for purposes of limitation. Descriptions of features within each example embodiment should typically be considered as available for other same as or similar features or aspects in other example embodiments.

While one or more example embodiments have been described with reference to the figures, it will be understood by those of ordinary skill in the art that various changes in form and details may be made therein without departing from the spirit and scope as defined by the following claims.

What is claimed is:

1. A synapse circuit connecting a plurality of neuron circuits, the synapse circuit comprising:
a first memristor connected to a pre-synaptic neuron circuit;
a second memristor connected to the pre-synaptic neuron circuit; and
an adder configured to output a sum of signals, respectively output from the first and second memristors, to a post-synaptic neuron circuit.

2. The synapse circuit of claim 1, wherein the first and second memristors are connected to each other in a parallel structure.

3. The synapse circuit of claim 2, wherein the first and second memristors are connected to each other in a same polarity direction.

4. The synapse circuit of claim 1, wherein a connection strength between the pre-synaptic neuron circuit and the post-synaptic neuron circuit is changed according to a conductance of at least one of the first and second memristors.

5. The synapse circuit of claim 1, wherein,
the first memristor is configured to perform long-term potentiation (LTP), and
the second memristor is configured to perform long-term depression (LTD).

6. The synapse circuit of claim 5, wherein the synapse circuit is configured to potentiate a connection strength between the pre-synaptic neuron circuit and the post-synaptic neuron circuit, whereby
a conductance of the first memristor is increased, and
a conductance of the second memristor is maintained.

7. The synapse circuit of claim 5, wherein the synapse circuit is configured to depress a connection strength between the pre-synaptic neuron circuit and the post-synaptic neuron circuit, whereby
a conductance of the first memristor is maintained, and
a conductance of the second memristor is increased.

8. A unit cell of a neuromorphic circuit, the unit cell comprising:
a pre-synaptic neuron circuit;
a post-synaptic neuron circuit; and
a synapse circuit configured to connect the pre-synaptic neuron circuit and the post-synaptic neuron circuit,
wherein the synapse circuit is configured to output a sum of signals, respectively output from two memristors connected to the pre-synaptic neuron circuit, to the post-synaptic neuron circuit.

9. The unit cell of claim 8, wherein the two memristors are connected to each other in a parallel structure.

10. The unit cell of claim 9, wherein the two memristors are connected to each other in a same polarity direction.

11. The unit cell of claim 8, wherein a connection strength between the pre-synaptic neuron circuit and the post-synaptic neuron circuit is changed according to a conductance of at least one of the two memristors.

12. The unit cell of claim 8, wherein one of the two memristors is configured to perform long-term potentiation (LTP), and the other one of the two memristors is configured to perform long-term depression (LTD).

13. The unit cell of claim 12, wherein the unit cell is configured to potentiate a connection strength between the pre-synaptic neuron circuit and the post-synaptic neuron circuit, whereby
a conductance of the one memristor configured to perform LTP is increased, and
a conductance of the other memristor configured to perform LTD is maintained.

14. The unit cell of claim 12, wherein the unit cell is configured to depress connection strength between the pre-synaptic neuron circuit and the post-synaptic neuron circuit, whereby
a conductance of the one memristor configured to perform LTP is maintained, and
a conductance of the other memristor configured to perform LTD is increased.

15. A neuromorphic circuit comprising:
a plurality of pre-synaptic neuron circuits;
a plurality of post-synaptic neuron circuits; and
a plurality of synapse circuits arranged in a grid structure, each synapse circuit including two memristors, and configured to output a sum of signals respectively output from the two memristors,
wherein,
the plurality of synapse circuits on a same row in the grid structure are connected to one of the plurality of pre-synaptic neuron circuits, and
the plurality of synapse circuits on a same column in the grid structure are connected to one of the plurality of post-synaptic neuron circuits.

16. The neuromorphic circuit of claim 15, wherein a plurality of spiking signals, which have different phases and are respectively fired by the plurality of pre-synaptic neuron circuits, are respectively input to the synapse circuits in different sections of an operation cycle of each of the synapse circuits.

17. The neuromorphic circuit of claim 15, wherein the two memristors included in each of the plurality of synapse circuits are connected to each other in a parallel structure.

18. The neuromorphic circuit of claim 15, wherein a connection strength between the one of the pre-synaptic neuron circuits and the one of the post-synaptic neuron circuits, which are connected to each other by a corresponding synapse circuit, is changed according to a conductance of each of the two memristors included in the corresponding synapse circuit.

19. The neuromorphic circuit of claim 18, wherein the neuromorphic circuit is configured to potentiate the connection strength, whereby
a conductance of one of the two memristors performing long-term potentiation (LTP) is increased, and
a conductance of the other of the two memristors performing long-term depression (LTD) is maintained.

20. The neuromorphic circuit of claim 18, wherein the neuromorphic circuit is configured to depress the connection strength,
a conductance of one of the two memristors performing long-term potentiation (LTP) is maintained, and
a conductance of the other of the two memristors performing long-term depression (LTD) is increased.
